(19) United States
(12) Patent Application Publication
(10) Pub. No.: US 2017/0346053 A1
(43) Pub. Date: Nov. 30, 2017

(54) BATTERY FOR A MOTOR VEHICLE AND MOTOR VEHICLE

(71) Applicant: AUDI AG, Ingolstadt (DE)

(72) Inventors: Erdal ACIKGOEZ, Reichertshofen (DE); Jörg SCHMIDT, Ingolstadt (DE)

(73) Assignee: AUDI AG, Ingolstadt (DE)

(21) Appl. No.: 15/536,701

(22) PCT Filed: Dec. 11, 2015
(86) PCT No.: PCT/EP2015/079495

§ 371 Date: Jun. 16, 2017

(30) Foreign Application Priority Data
Dec. 16, 2014 (DE) 10 2014 018 746.2

(51) Int. Cl. H01M 2/10; B60L 11/18

(52) U.S. Cl. CPC H01M 2/1077; B60L 11/1879; B60L 11/1877; H01M 2220/20

(57) ABSTRACT

A battery for a motor vehicle, in particular a high-voltage battery, including battery cells and a housing. The walls of the housing at the same time define a housing space, in which the battery cells are placed in a predetermined arrangement. Between the battery cells that are arranged in the housing space is provided an intermediate space. A passage element extends through the intermediate space from a first wall of the walls of the housing to a second wall on the opposite side of the walls of the housing.

The invention relates to a battery for a motor vehicle, in particular a high-voltage battery. The invention also relates to a motor vehicle provided with a first brake circuit and with a second brake circuit.

Battery systems for automotive applications can be constructed in such a way that they are built independently of adjacent components, or installed in the vehicle. The adjacent components, such as for example lines such as brake lines, cooling lines or cabling, are routed around the battery. This design arrangement is in particular the case with underfloor batteries. Such a mounting arrangement can lead to conflicts related to the accommodation of other structural elements of the motor vehicle, because alternative installation areas must then be found for the other structural elements.

Since the space must be reserved in the vehicle for these lines and for other components parts, restrictions are imposed on the dimensions of the battery. This can lead for example to a lower energy content of the battery and thus also to a smaller traveling range for the vehicle. The z dimension is particularly important with underfloor batteries for the design realization and conversion. The z dimension in this case determines the region between the underfloor of the motor vehicle and the floor of the motor vehicle on which are for example arranged the seats of the vehicle. The supply lines or other component parts take into account important parts of the z dimension, which can be very important for the battery.

From DE 10 2013 001 309 B4 is known a battery for a motor vehicle. This battery is provided with a battery housing that has a receiving space that is at least partially delimited by the wall.

In the wall is provided at least one line element through which a cooling medium can flow, wherein in at least one of the receiving spaces is also provided at least one transmission element, which is delimited by the wall of the battery housing, for transmitting electric current from a current source to a consumer of electricity.

The objective of the present invention is to save the installation space available in a motor vehicle.

This objective is achieved by the subject matter of the independent patent claims. Advantageous embodiments of the invention are described in the features of the dependent claims.

This objective is achieved in accordance with the invention with a battery for a motor vehicle, in particular a high-voltage battery, which comprises battery cells in a housing. The walls of the housing delimit in this case a housing space, in which the battery cells are arranged in a predetermined arrangement. Between the battery cells that are arranged in the housing space is provided an intermediate space, through which a passage element extends through the interim space from a first wall of the walls of the housing to an opposite second wall of the walls of the housing. In other words, the passage elements pass through the housing of the battery or are installed in it. Useable free spaces available inside the housing of the battery are used for this purpose, which are not occupied by the battery cells, in order to pass through them or arrange there the passage elements. By usable free spaces or intermediate spaces are meant spaces and/or gaps available between the battery cells and/or between the battery cells and the walls in the housing. The dimensioning of the usable free space or intermediate space can be determined by the dimensioning of the battery, which is to say based on the distance between the respective battery cells in the housing to each other. In other words, the passage elements are routed through the battery where there is space available in the housing space based on the construction. It is advantageous if the passage element can be designed as a brake line or an electric signal line. In particular, the passage element is independent of a cooling circuit and/or of an electric current circuit of the battery cells.

This results in the advantage that the battery does not need to have increased dimensions in order to accommodate an additional passage element. As long as no installation space is required for the passage element outside of the battery, the battery does not need to have smaller dimensions and therefore a greater energy content of the battery and a greater driving range can be provided. In addition, more installation space is constantly available in the z dimension with the integration of the passage element in the battery housing, and thus also a greater freedom is provided for the construction.

With the integration of the passage element in the battery housing, installation space conflicts, or so called package problems, can be avoided because the package element is neutral with respect to the installation space, in particular because it can be accommodated without requiring additional space in the motor vehicle. A very high package density can thus be achieved in the motor vehicle, so that a particularly high number of functional elements can be integrated in a predetermined installation space of the motor vehicle.

According to an embodiment of the invention, the wall of the housing is penetrated by the passage element and a connecting element or a coupling location is provided at an outer side of the wall on which the passage element is arranged. The coupling locations can be provided for example on the front side and on the rear side of the battery, and they can be in particular designed as an adapter element or as a connecting piece in order to make the positioning of the passage element inside the battery independent of the position of the corresponding line element in the vicinity of the battery, to which the passage element is connected. In order words, the passage element ends in the vicinity of the battery housing via a connecting element and/or a coupling element. The connecting element can be for example a flange, in particular a connecting flange, or a piece of a tube, in particular a curved or angled piece of a tube. The passage element can be fluidically and/or electrically connected by means of the connecting element and/or coupling element, and/or by means of a line element for technical signals and/or a circuit in which is circulated a fluid of the motor vehicle. This results in the advantage that the arrangement of the passage element through the battery is not fixed to a single location, since it can be instead routed flexibly through the battery housing.

According to another embodiment of the invention, a section of the passage element is designed as a T-shaped piece. In this manner, the passage element can be adapted in a more flexible way to the intermediate space between the battery cells. In particular, the battery can be arranged in a cross-section or in a branching region of the power system for which the passage element is provided. Furthermore, the passage element can be also subdivided into a first passage part and a second passage part, wherein the first and the second passage parts can be mutually connected to each other with a connecting element. The passage element can be in this case designed as a T-shaped piece and/or as an angle piece. This has the advantage that the passage elements can be flexibly routed also through intermediate spaces that are provided with a complex geometry.

The invention also relates to a motor vehicle provided with a first brake circuit and with a second brake circuit, wherein the first brake circuit is arranged in the front of the motor vehicle and the second brake circuit is arranged in the rear of the vehicle. The first and the second brake circuit are at the same time mutually connected to each other with a passage element, in particular a brake line, which extends through a battery. For this purpose, the battery can be preferably arranged in the underfloor of the motor vehicle. The battery is in particular provided according to an embodiment of the battery according to the invention.

The invention will now be explained in more detail. The figures show the following:

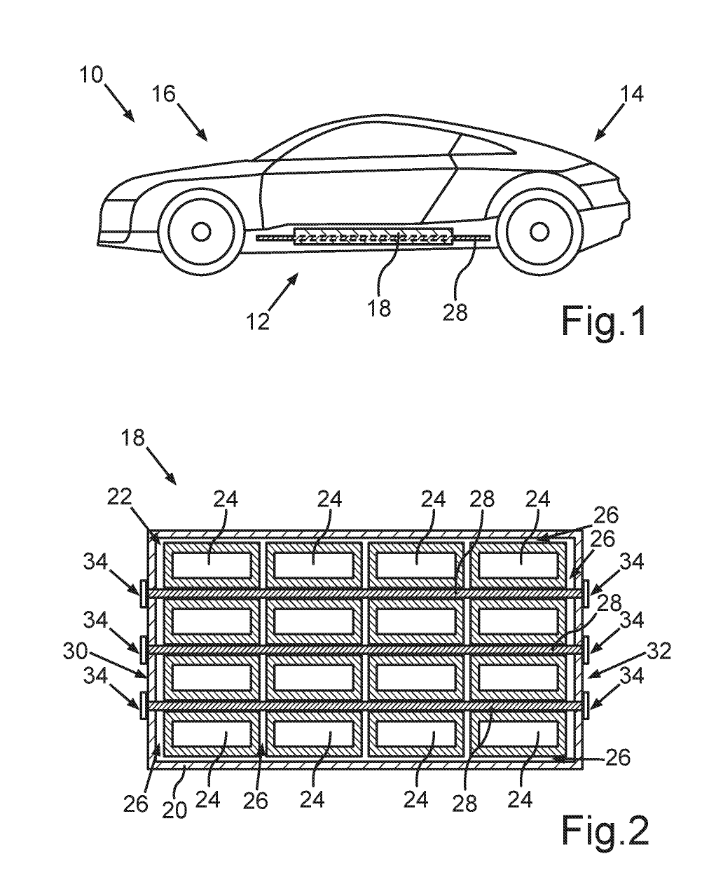

FIG. 1 a schematic representation of a motor vehicle provided with a battery according to the invention;

FIG. 2 a schematic representation of the battery in a sectional view;

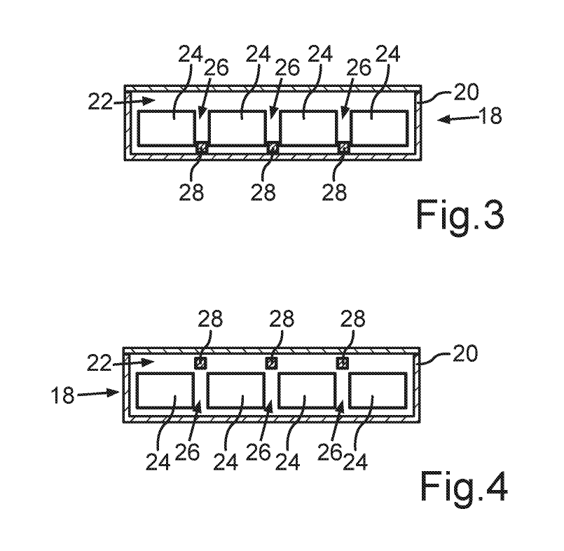

FIG. 3 a schematic representation of the batter of FIG. 2 in a cross-sectional view; and

FIG. 4 a schematic representation of the battery of FIG. 2 in a cross-sectional view.

The embodiments discussed below are preferred embodiment of the invention. However, in these embodiments, the components described in the embodiments represent in each case individual features of the invention that should be considered as being independent of each other which further modify the invention as component parts of the invention in other combinations than those that are shown. Furthermore, the embodiments described can be also further complemented by other, already described features of the invention.

FIG. 1 shows a schematic representation of a motor vehicle 10, which is preferably designed as an automobile, in particular as a passenger car. A battery 18 is in this case arranged in an underfloor 12 of the motor vehicle 10. Passage elements 28, shown here only schematically, extend through the battery 18 of the motor vehicle 10, from the motor vehicle rear 14 to the front 16 of the motor vehicle. The passage element 28 can be designed for example as a brake line. The brake line can be at the same time connected to a first brake circuit and to a second brake circuit (not shown in FIG. 1) of the motor vehicle. The first brake circuit can be in this case arranged at the front 16 of the motor vehicle and the second brake circuit can be arranged at the rear 14 of the motor vehicle. In order to connect both brake circuits, the brake line, illustrated by the dashed line in FIG. 1, can be routed through the battery 18. The passage element 28 can be also a cooling circuit and/or a signal line. Various other types of the passage element 28 can be also routed through the battery 18.

FIG. 2 shows again schematically the battery 18, which can be designed in particular as a high-voltage battery. The battery 18 in this case comprises a housing 20, whose walls delimit a housing space 22. The battery cells 24 are placed in the housing space 22 in a predetermined arrangement. Between the battery cells 24 placed in the housing space 22 is provided an intermediate space 26. A passage element 28 extends through this intermediate space 26 from a first wall 30 of the walls of the housing 30 to a second wall 32 of the walls of the housing located on the opposite side. In other words, the passage element 28 is routed through the battery 18 where there is space available based on the construction design.

Furthermore, the passage element 28 can be also subdivided within the battery 18 into a first line part and a second line part (not shown in FIG. 2), wherein the first and the second line parts are mutually connected to one another with a connecting element (not shown in FIG. 2). The passage element 28 can be also composed of several line parts. The connecting element can in this case be designed as a T-shaped piece or as an angle piece. As a result, the passage element 28 can be routed through the housing 20 of the battery 18 between the battery cells 24 not only in a straight line (as shown in FIG. 2), but it can be also for example adapted in a flexible manner. For example, the passage element 28 can be inserted between the battery cells 24 in a step-like manner. Several line parts of the passage element 28 can thus be connected with a connecting element in order to match it to the usable free space between the battery cells 24.

As one can see from FIG. 2, the passage element cuts or penetrates through the first wall 30 and through the wall 32 of the housing 20 on the opposite side. A connecting element 34 is arranged on an outer side of the first wall 30 and of the second wall 32, which is coupled to the passage element 28. In other words, the passage element 28 ends in the vicinity of the housing 20 of the battery 18 with a connecting element 34, through which the passage element 28 is connected fluidically and/or electrically and/or with a line element for technical signals and/or with a circuit of the motor vehicle 10 in which is circulated a fluid. The passage element 28 can thus be coupled in this manner in a particularly simple manner with an electrical and or technical signal line element and/or with a circuit of the motor vehicle 10.

FIGS. 3 and 4 illustrate a schematic cross-section of the battery 18 of FIG. 2. The battery cells 24 are in this case arranged next to each other at a predetermined distance to each other. Between the battery cells 24 is provided an intermediate space 26 at a predetermined distance, through which is placed the passage element 28 on the bottom of the housing 20 of the battery 18. In FIG. 4, however, the passage elements 28 are arranged above the battery cells 24. As illustrated in FIG. 3 and FIG. 4, the passage element 28 is not bound to a predetermined location in the intermediate space 26, but instead it can be arranged depending on the dimensioning of the battery 18 at different locations in the housing 20 in each intermediate space 26.

The overall result is a battery system that is provided with integrated brake lines. These lines are routed through a battery housing. For this purpose, the usable free space locations inside the battery housing are used in order to route the line through them. To make the assembly of the battery even more independent of these lines, coupling location are arranged before and after the battery.

1-8. (canceled)

9. A battery for a motor vehicle, in particular a high-voltage battery, comprising:
battery cells and a housing, wherein a plurality of walls delimit a housing space in which the battery cells are arranged in a predetermined arrangement, wherein an intermediate space is provided between the battery cells that are arranged in the housing space, wherein a passage element extends through the intermediate space from a first wall of the walls of the housing to a first wall on the second wall on the opposite side of the walls of the housing.

10. The battery according to claim 9, wherein the passage element penetrates through a wall of the plurality of walls, and a connecting element is arranged at an outer side of the wall at the passage element.

11. The battery according to claim 9, wherein the passage element is provided with at least one brake line.

12. The battery according to claim 9, wherein the passage element is provided with at least one cooling line.

13. The battery according to claim 9, wherein the passage element is provided with at least one signal line.

14. The battery according to claim 9, wherein a section of the passage element is designed as a T-shaped piece.

15. A motor vehicle, comprising:
a first brake circuit and a second brake circuit, wherein the first brake circuit is arranged in a front of the vehicle and the second brake circuit is arranged on a rear of the vehicle, wherein the first and the second brake circuits are mutually connected to one another through a passage element, which extends through a battery.

16. The motor vehicle according to claim 15, wherein the battery is arranged in a subfloor of the motor vehicle.
